(19) United States
(12) Patent Application Publication
(10) Pub. No.: US 2014/0086135 A1
(43) Pub. Date: Mar. 27, 2014

(54) Method And Apparatus For Indicating EPDCCH Subframe Allocation

(71) Applicant: Alcatel-Lucent USA Inc., Murray Hill, NJ (US)

(72) Inventors: Shin Horng WONG, Chippenham (GB); Matthew P J BAKER, Murray Hill, NJ (US); Sigen YE, New Providence, NJ (US); Chandrika K. WORRALL, Newbury (GB)

(73) Assignee: Alcatel-Lucent USA Inc., Murray Hill, NJ (US)

(21) Appl. No.: 13/629,013

(22) Filed: Sep. 27, 2012

(51) Int. Cl. H04W 4/00; H04W 4/06

(52) U.S. Cl. 370/312; 370/328

(57) ABSTRACT

A method of specifying, for a user equipment (UE), non-enhanced physical downlink control channel (EPDCCH) subframes from among a plurality of subframes includes sending one or more first bitmaps from the base station to the UE, each of the one or more first bitmaps being logically mapped to the plurality of subframes and identifying first subframes, the first subframes being subframes, from among the plurality of subframes, that belong to one of one or more first groups; sending a second bitmap from the base station to the UE, the second bitmap being logically mapped to the first subframes and identifying the non-EPDCCH subframes from among the first subframes, the non-EPDCCH subframes being subframes that are not to be monitored by the UE for an EPDCCH; and sending the plurality of subframes from a base station to the UE.

### BACKGROUND

1. Field

Example embodiments relate generally to providing and/or using information regarding an allocation of enhanced physical downlink control channel (EPDCCH) subframes.

2. Related Art

In Release 11 of LTE-Advanced, a new control channel known as the Enhanced Physical Downlink Control Channel (EPDCCH) is provided which is transmitted over or more subframes in a radio frame. EPDCCH is an enhancement to the Physical Downlink Control Channel (PDCCH) which may offer higher capacity for control channels and efficient use of resources via spatial reuse multi-user multiple input multiple output (MU-MIMO) and beamforming.

### SUMMARY

According to at least one example embodiment, a method of specifying, for a user equipment (UE), non-enhanced physical downlink control channel (EPDCCH) subframes from among a plurality of subframes may include sending one or more first bitmaps from a base station to the UE, each of the one or more first bitmaps being logically mapped to the plurality of subframes and identifying first subframes, the first subframes being subframes from among the plurality of subframes that belong to one of one or more first groups; sending a second bitmap from the base station to the UE, the second bitmap being logically mapped to the first subframes and identifying the non-EPDCCH subframes from among the first subframes, the non-EPDCCH subframes being subframes that are not to be monitored by the UE for an EPDCCH; and sending the plurality of subframes from a base station to the UE.

The method may further include determining the non-EPDCCH subframes from among the plurality of subframes; and generating the second bitmap at the base station based on the determined non-EPDCCH subframes.

The one or more first bitmaps may be multicast-broadcast single frequency network (MBSFN) bitmaps, and the one or more first groups are one or more groups of MBSFN subframes from among the plurality of subframes.

According to at least one example embodiment, a method of determining, at a user equipment (UE), non-enhanced physical downlink control channel (non-EPDCCH) subframes from among a plurality of subframes may include receiving the plurality of subframes at the UE; receiving one or more first bitmaps at the UE, each of the one or more first bitmaps being logically mapped to the plurality of subframes and identifying first subframes, the first subframes being subframes from among the plurality of subframes that belong to one of one or more first groups; receiving a second bitmap at the UE, the second bitmap being logically mapped to the first subframes and identifying subframes from among the first subframes as non-EPDCCH subframes; determining which of the plurality of subframes are EPDCCH-possible subframes based on the second bitmap, the EPDCCH-possible subframes being subframes having an EPDCCH intended for the UE; and monitoring only the subframes determined to be EPDCCH-possible subframes for the EPDCCH.

The one or more first bitmaps may be multicast-broadcast single frequency network (MBSFN) bitmaps, and the one or more first groups are one or more groups of MBSFN subframes from among the plurality of subframes.

The method may further include receiving a third bitmap at the UE, the plurality of subframes being divided into a plurality of frames, the third bitmap being logically mapped to a representative frame from among the plurality of frames, and identifying subframes from among the subframes in the representative frame as non-EPDCCH subframes; and forming a fourth bitmap by repeating the third bitmap once for each frame in the plurality of frames, wherein the determining includes determining, as the EPDCCH-possible subframes, subframes from among the plurality of subframes that are not identified as non-EPDCCH subframes by either the second bitmap or the fourth bitmap.

The method may further include receiving a third bitmap at the UE, the plurality of subframes being divided into a plurality of frames, the third bitmap being logically mapped to a representative frame from among the plurality of frames, and identifying subframes from among the subframes in the representative frame as EPDCCH-including subframes; and forming a fourth bitmap by repeating the third bitmap once for each frame in the plurality of frames, wherein the determining includes determining, as the EPDCCH-possible subframes, the EPDCCH-including subframes, and subframes from among the plurality of subframes that are not identified as non-EPDCCH subframes by the second bitmap.

According to at least one example embodiment, a network element may include a processing unit configured to control operations for specifying, for a user equipment (UE), non-enhanced physical downlink control channel (EPDCCH) subframes from among a plurality of subframes, the operations including sending one or more first bitmaps from the network element to the UE, each of the one or more first bitmaps being logically mapped to the plurality of subframes and identifying first subframes, the first subframes being subframes from among the plurality of subframes that belong to one of one or more first groups; sending a second bitmap from the network element to the UE, the second bitmap being logically mapped to the first subframes and identifying the non-EPDCCH subframes from among the first subframes, the non-EPDCCH subframes being subframes that are not to be monitored by the UE for an EPDCCH; and sending the plurality of subframes from a base station to the UE.

According to at least one example embodiment, a mobile device may include a processing unit configured to control operations for determining non-enhanced physical downlink control channel (non-EPDCCH) subframes from among a plurality of subframes, the operations including, receiving the plurality of subframes at the mobile device; receiving one or more first bitmaps at the mobile device, each of the one or more first bitmaps being logically mapped to the plurality of subframes and identifying first subframes, the first subframes being subframes from among the plurality of subframes that belong to one of one or more first groups; receiving a second bitmap at the mobile device, the second bitmap being logically mapped to the first subframes and identifying subframes from among the first subframes as non-EPDCCH subframes; determining which of the plurality of subframes are EPDCCH-possible subframes based on the second bitmap, the EPDCCH-possible subframes being subframes having an EPDCCH intended for the mobile device; and monitoring only the subframes determined to be EPDCCH-possible subframes for the EPDCCH.

### BRIEF DESCRIPTION OF THE DRAWINGS

At least one example embodiment will become more fully understood from the detailed description provided below and the accompanying drawings, wherein like elements are represented by like reference numerals, which are given by way of illustration only and thus are not limiting of example embodiments and wherein:

FIG. 1 is a diagram illustrating a portion of a wireless communications network.

FIG. 2A is a diagram illustrating an example structure of the user equipment (UE) 110 illustrated in FIG. 1.

FIG. 2B is a diagram illustrating an example structure of the evolved node B (eNB) 120 illustrated in FIG. 1.

FIG. 3 illustrates an example structure of a multicast broadcast single frequency network (MBSFN) bitmaps and an overall bitmap.

FIG. 4 illustrates an example of a relationship between a primary bitmap, B_{PRIMARY}, and the overall bitmap.

FIG. 5 illustrates a relationship between B_{PRIMARY} and a first non-EPDCCH bitmap.

FIG. 6 illustrates the secondary bitmap B_{SECONDARY}.

FIG. 7 illustrates a relationship between the first non-EPDCCH bitmap, a second non-EPDCCH bitmap and a combined non-EPDCCH bitmap.

### DETAILED DESCRIPTION OF EXAMPLE EMBODIMENTS

Various at least one example embodiment will now be described more fully with reference to the accompanying drawings in which some example embodiments are shown.

Detailed illustrative embodiments are disclosed herein. However, specific structural and functional details disclosed herein are merely representative for purposes of describing at least one example embodiment. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

As used herein, the term user equipment (UE) may be considered synonymous to, and may hereafter be occasionally referred to, as a terminal, mobile, mobile unit, mobile station, mobile user, access terminal (AT), subscriber, user, remote station, access terminal, receiver, etc., and may describe a remote user of wireless resources in a wireless communication network. The term enhanced Node B (eNB), may be considered synonymous to and/or referred to as a base station (BS), base transceiver station (BTS), NodeB, access point (AP), etc. and may describe equipment that provides the radio baseband functions for data and/or voice connectivity between a network and one or more users.

Exemplary embodiments are discussed herein as being implemented in a suitable computing environment. Although not required, exemplary embodiments will be described in the general context of computer-executable instructions, such as program modules or functional processes, being executed by one or more computer processors or CPUs. Generally, program modules or functional processes include routines, programs, objects, components, data structures, etc. that performs particular tasks or implement particular abstract data types.

The program modules and functional processes discussed herein may be implemented using existing hardware in existing communication networks. For example, program modules and functional processes discussed herein may be implemented using existing hardware at existing network elements or control nodes. Such existing hardware may include one or more digital signal processors (DSPs), application-specific-integrated-circuits (ASICs), field programmable gate arrays (FPGAs) computers or the like.

In the following description, illustrative embodiments will be described with reference to acts and symbolic representations of operations (e.g., in the form of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

### Overview of Network Architecture

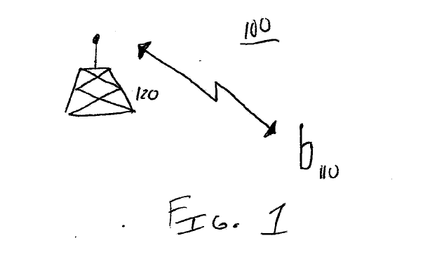

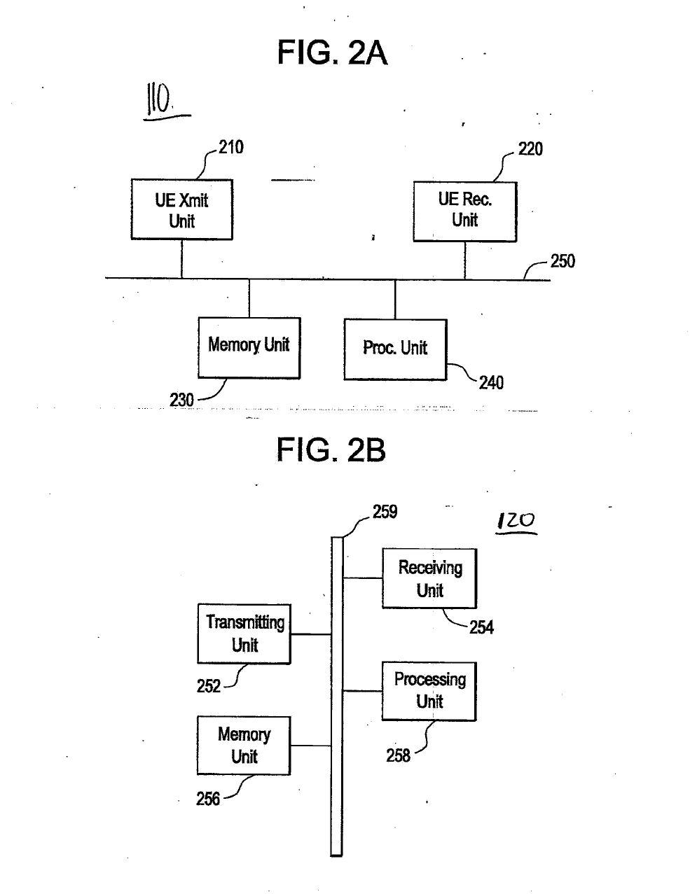

FIG. 1 illustrates a portion of a wireless communication network 100. The wireless communication network 100 may follow, for example the long term evolution (LTE) protocol. The wireless communication network 100 may include a UE 110 and an evolved NodeB (eNB) 120. The eNB 120 may provide wireless coverage for the UE 110 within a cell or geographical region associated with the eNB 120. Accordingly, the eNB 120 and the UE 110 are both capable of transmitting and receiving data to and from one another, wirelessly. The UE 110 may be, for example, a mobile phone, smart phone, computer, or personal digital assistant (FDA). Further, wireless communications network 100 implements the Enhanced Physical Downlink Control Channel (EPDCCH) as defined, for example, by technical specification 3GPP TS 36.211 V11.0.0. Accordingly the eNB 120 may send control data to the UE 110 using the EPDCCH. The eNB 120 and UE 110 will be discussed in greater detail below with reference to FIGS. 2A and 2B.

Though not pictured for simplicity, the wireless communications network 100 may include any number of additional eNBs and UEs. Further, the wireless communications network 100 may include other elements of an LTE core network including, for example, a mobility management entity (MME), a serving gateway (SGW), and a packet data network (PDN) gateway (PGW).

FIG. 2A is a diagram illustrating an example structure of the UE 110 illustrated in FIG. 1. While only the UE 110 is shown, it should be understood that other UEs in the wireless communications network 100 may have the same structure.

The UE 110 may include, for example, a UE transmitting unit 210, a UE receiving unit 220, a memory unit 230, a processing unit 240, and a data bus 250.

The UE transmitting unit 210, UE receiving unit 220, memory unit 230, and processing unit 240 may send data to and/or receive data from one another using the data bus 250. The UE transmitting unit 210 is a device that includes hardware and any necessary software for transmitting wireless signals on an uplink (reverse link) channel including, for example, data signals or control signals, via one or more wireless connections to other wireless devices (e.g., eNBs).

The UE receiving unit 220 is a device that includes hardware and any necessary software for receiving wireless signals on a downlink (forward link) channel including, for example, data signals or control signals, via one or more wireless connections to other wireless devices (e.g., eNBs).

The memory unit 230 may be any storage medium capable of storing data including magnetic storage, flash storage, etc.

The processing unit 240 may be any device capable of processing data including, for example, a microprocessor configured to carry out specific operations based on input data, or capable of executing instructions included in computer readable code including, for example code stored in the memory unit 230.

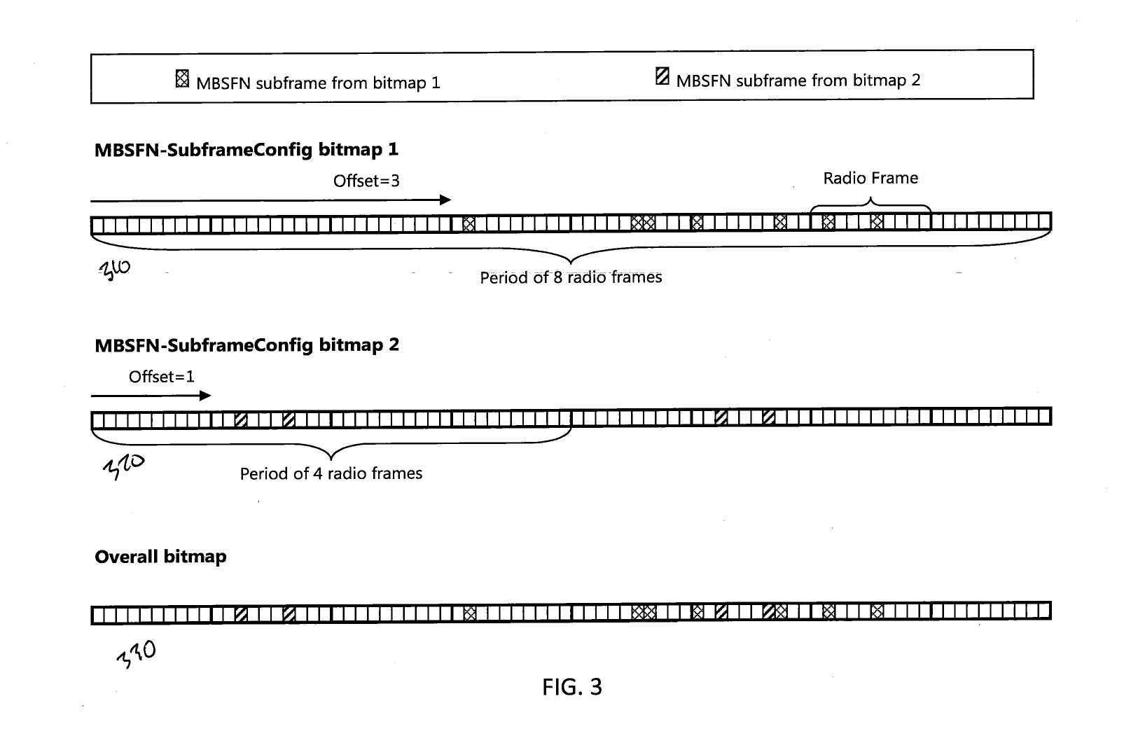

According to at least one example embodiment, operations described herein as being performed by a UE may be performed by the UE 110 having the structure illustrated in FIG. 2A. For example, the memory unit 230 may store executable instructions corresponding to each of the operations described with reference to FIGS. 3-7 as being performed by a UE. Further, the processing unit 240 may be configured perform each of the operations described with reference to FIGS. 3-7 as being performed by a UE, for example, by executing executable instructions stored in the memory unit 230.

FIG. 2B is a diagram illustrating an example structure of the eNB 120. Referring to FIG. 2B, the eNB 120 may include, for example, a data bus 259, a transmitting unit 252, a receiving unit 254, a memory unit 256, and a processing unit 258.

The transmitting unit 252, receiving unit 254, memory unit 256, and processing unit 258 may send data to and/or receive data from one another using the data bus 259.

The transmitting unit 252 is a device that includes hardware and any necessary software for transmitting signals including, for example, control signals or data signals via one or more wired and/or wireless connections to other network elements in communications network 105. For example, the transmitting unit 252 may be configured to send control signals to UEs within wireless communications network 100 over the EPDCCH. As another example, the transmitting unit 252 may be additionally configured to send control signals to UEs within wireless communications network 100 using broadcast or dedicated radio resource control (RRC) signaling.

The receiving unit 254 is a device that includes hardware and any necessary software for receiving wireless signals including, for example, control signals or data signals via one or more wired and/or wireless connections to other network elements in the communications network 105.

The memory unit 256 may be any device capable of storing data including magnetic storage, flash storage, etc.

The processing unit 258 may be any device capable of processing data including, for example, a microprocessor configured to carry out specific operations based on input data, or capable of executing instructions included in computer readable code including, for example code stored in the memory unit 256.

According to at least one example embodiment, operations described herein as being performed by an eNB may be performed by the eNB 120 having the structure illustrated in FIG. 2B. For example, the memory unit 256 may store executable instructions corresponding to each of the operations described with reference to FIGS. 3-7 as being performed by an eNB. Further, the processing unit 258 may be configured perform each of the operations described with reference to FIGS. 3-7 as being performed by a eNB, for example, by executing executable instructions stored in the memory unit 256.

Method of Indicating which Sub-Frames to Monitor for EPDCCH

As is discussed above, the eNB 120 sends control data to the UE 110 using the EPDCCH. EPDCCH shares the same resource space as that used by the Physical Downlink Shared Channel (PDSCH). However, the EPDCCH may not be allocated in every subframe. For example, according to at least one example embodiment, subframes containing a Physical Multicast Channel (PMCH) do not contain the EPDCCH. UEs not supporting multimedia broadcast multicast service (MBMS) may not be aware of which subframes contain a PMCH. Furthermore there may be other reasons for not sending the EPDCCH in some subframes apart from subframes containing PMCH. Consequently, there is a need to provide UEs with information indicating which subframes do, or do not, include the EPDCCH so the UEs will know which subframes to monitor, or which subframes not to monitor, for the EPDCCH.

One method for providing information indicating which subframes to monitor includes providing a bitmap corresponding to a period of the PMCH. The bitmap corresponding to the period of the PMCH has a number entries equal to the number of subframes in a period of the PMCH, and indicates which of the subframes within the period of the PMCH should be monitored for the EPDCCH. However, the period of the PMCH may be, for example, 320 subframes. Accordingly, the bitmap corresponding to the period of the PMCH would need to be at least 320 bits long. The sending of the 320 bit long bitmap, for example from eNB 120 to the UE 110, may produce a substantial amount of overhead for the wireless system 100. Accordingly, it would be desirable to implement a method of indicating to a UE which subframes to monitor for the EPDCCH which requires less data to be sent from, for example, the eNB 120 to the UE 110. A method of indicating which sub-frame to monitor for EPDCCH will now be discussed in greater detail below.

As is known, in a system following the LTE protocol, system information may be sent from an eNB to UE over the PDSCH in the form of an RRC message. For example, information identifying multicast broadcast single frequency network (MBSFN) subframes may be included in the SIB2 system information block. The SIB2 system information block may be sent from an eNB to a UE over the PDSCH in the form of an RRC message. For example, the SIB2 system information block may include an MBSFN-SubframeConfig information element (IE) which includes one or more MBSFN bitmaps identifying MBSFN subframes. MBSFN subframes are used for various features including MBMS, MBSFN, and positioning.

For example, the MBSFN bitmaps may each be logically mapped to a plurality of subframes in radio frames being transmitted from an eNB to a UE. For example, the MBSFN bitmaps may include a “0” for each subframe that is not an MBSFN subframe, and the MBSFN bitmaps may include a “1” for each subframe that is an MBSFN subframe. Accordingly, a UE receiving the SIB2 including the one or more MBSFN bitmaps can generate an overall bitmap identifying MBSFN subframes, from among the plurality of subframes in radio frames being transmitted to the UE, based on the MBSFN bitmaps. FIG. 3 illustrates an example structure of MBSFN bitmaps included in the SIB2 and an overall bitmap.

Referring to FIG. 3, FIG. 3 illustrates an example where the system information block SIB2 includes two bitmaps: first MBSFN bitmap 310 and second MBSFN bitmap 320. Additionally, the system information block SIB2 may include offset information and periodicity information corresponding to each of the first and second MBSFN bitmaps 310 and 320. In FIG. 3, MBSFN subframes identified by the first MBSFN bitmap 310 are indicated by a diamond pattern, and MBSFN subframes identified by the second MBSFN bitmap 320 are indicated by a pattern of upward diagonal lines. For example, the offset information for each bitmap may include 3 bits, and periodicity information for each bitmap may include 6 bits. In the example illustrated in FIG. 3, the first MBSFN bitmap 310 may be a 24 bit bitmap having an offset of 3 radio frames and a periodicity of 8 radio frames; and the second MBSFN bitmap 320 may be a 6 bit bitmap having an offset of 1 radio frame and a periodicity of 4 radio frames. A UE receiving the system information block SIB2 including first and second MBSFN bitmaps 310 and 320 can use the first and second MBSFN bitmaps 310 and 320 to construct an overall bitmap 330. For example, the overall bitmap 330 may be constructed by a UE by performing an OR operation on first and second MBSFN bitmaps 310 and 320. The UE may then refer to the overall bitmap to determine which subframes are MBSFN subframes.

According to at least one example embodiment, the one or more MBSFN bitmaps, which are already present in system information block SIB2 sent to a UE by an eNB, may be exploited in order to implement a low overhead mechanism for providing the UE with information indicating which subframes to monitor for the EPDCCH.

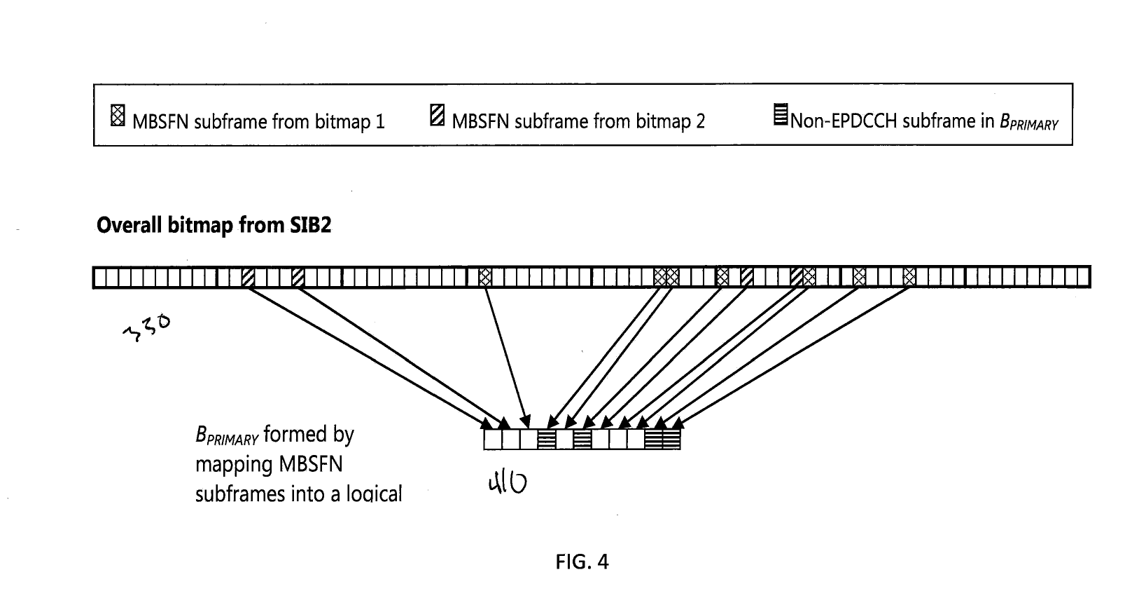

FIG. 4 illustrates an example of a relationship between a primary bitmap, B_{PRIMARY}, and the overall bitmap 310. Referring to FIG. 4, B_{PRIMARY} 410 is a bitmap which identifies non-EPDCCH subframes for a UE. In FIG. 4, MBSFN subframes identified by the first MBSFN bitmap 310 are indicated by a diamond pattern, MBSFN subframes identified by the second MBSFN bitmap 320 are indicated by a pattern of upward diagonal lines, and non-EPDCCH subframes identified by B_{PRIMARY} 410 are indicated by a pattern of horizontal lines.

As used herein, the term non-EPDCCH subframe refers to a subframe which does not need to be monitored by the UE receiving the subframe. It is possible for an eNB to send a subframe which is intended to be treated as an EPDCCH subframe by one or more UEs, but not by others. Accordingly, using UE 110 as an example, a subframe received by UE 110 may be a non-EPDDCH subframe with respect to the UE 110 so long as the subframe does not need to be monitored by the UE 110. For example, a subframe received at the UE 110 that includes the EPDCCH is still a non-EPDCCH subframe with respect to the UE 110 so long as the subframe is not intended to be treated as an EPDCCH subframe by the UE 110.

B_{PRIMARY} 410 may be generated, for example, at an eNB and sent from the eNB to a UE. B_{PRIMARY} 410 is logically mapped to the MBSFN subframes identified by the one or more MBSFN bitmaps in the system information block SIB2. For example, in a case where the SIB2 includes first and second MBSFN bitmaps 310 and 320, a total number entries in B_{PRIMARY} 410 may be equal to the total number of MBSFN subframes identified by first and second MBSFN bitmaps 310 and 320. For example, as is illustrated in FIG. 4, B_{PRIMARY} 410 includes an entry corresponding to each MBSFN subframe identified by the overall bitmap 310. Accordingly, B_{PRIMARY} 410 includes an entry corresponding to each MBSFN subframe identified by either of the MBSFN bitmaps 310 and 320.

As is stated above, B_{PRIMARY} 410 may indicate non-EPDCCH subframes. As is discussed above, non-EPDCCH subframes are subframes which are not intended to be treated as EPDCCH subframes by the UE receiving the subframes, and thus, should not be monitored for the EPDCCH by the UE receiving the subframes. A PMCH subframe is one example of a subframe which would be identified by B_{PRIMARY} 410 as a non-EPDCCH subframe. According to at least one example embodiment, B_{PRIMARY} 410 may include a “1” for each MBSFN subframe which does not include the EPDCCH, and B_{PRIMARY} 410 may include a “0” for each MBSFN subframe which does include the EPDCCH. Since the EPDCCH is sent by an eNB, an eNB sending the EPDCCH will be able to identify which subframes include the EPDCCH. Consequently, B_{PRIMARY} 410 can be formed at an eNB based on the information at the eNB regarding which subframes include the EPDCCH. Further, the eNB can send B_{PRIMARY} 410 to a UE using, for example, RRC signaling.

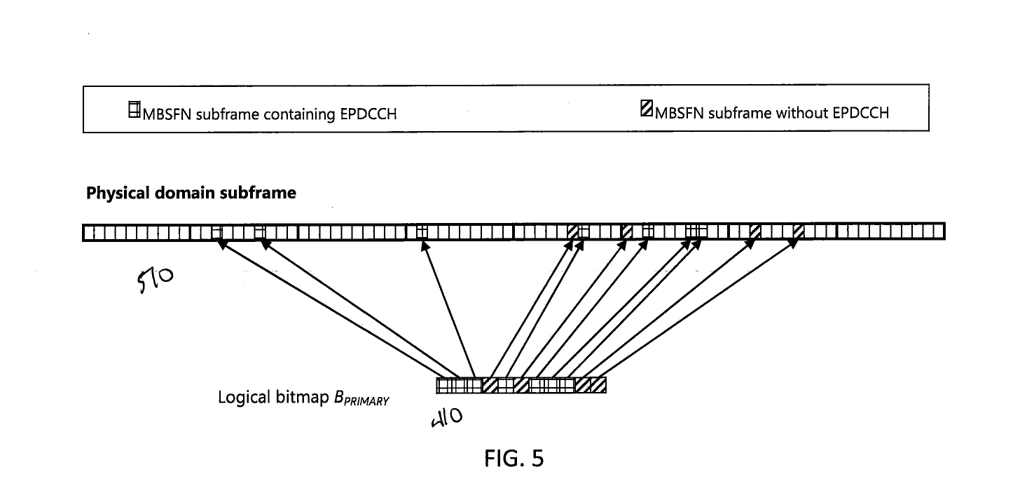

Once a UE receives B_{PRIMARY} 410, the UE may use B_{PRIMARY} along with the overall bitmap 310 to determine which subframes to monitor for the EPDCCH, and which subframes not to monitor for the EPDCCH. FIG. 5 illustrates a relationship between B_{PRIMARY} and a first non-EPDCCH bitmap 510. As is illustrated in FIG. 5, because the UE can determine the location of each MBSFN subframe based on the overall bitmap 310, and the UE can determine which of the MBSFN subframes are non-EPDCCH subframes based on B_{PRIMARY} 410, according to at least one example embodiment, the UE can form the first non-EPDCCH bitmap 510. In FIG. 5, MBSFN subframes including the EPDCCH (and corresponding entries in B_{PRIMARY} 410) are indicated by a window-pane pattern, and non-EPDCCH MBSFN subframes (and corresponding entries in B_{PRIMARY} 410) are indicated by a pattern of upward diagonal lines.

For example, in a case where the UE 110 generates the first non-EPDCCH bitmap 510 based on a plurality of subframes included in a plurality of frames sent to from the eNB 120 to the UE 110, the first non-EPDCCH bitmap 510 is logically mapped to the sent subframes such that consecutive entries in the first non-EPDCCH bitmap 510 correspond, respectively, to consecutive subframes from among the sent subframes. Further, according to at least one example embodiment, the first non-EPDCCH bitmap 510 may include a “1” for each sent subframe which does not include the EPDCCH intended for the UE receiving the subframe, and the first non-EPDCCH bitmap 510 may include a “0” for each sent subframe which does include the EPDCCH intended for the UE receiving the subframe. Consequently, according to at least one example embodiment, the UE 110 monitors for the EPDCCH during each subframe received from the eNB 120 which logically maps to a “0” in the first non-EPDCCH bitmap 510, and the UE 110 does not monitor for the EPDCCH during each subframe received from the eNB 120 which logically maps to a “1” in the first non-EPDCCH bitmap 510.

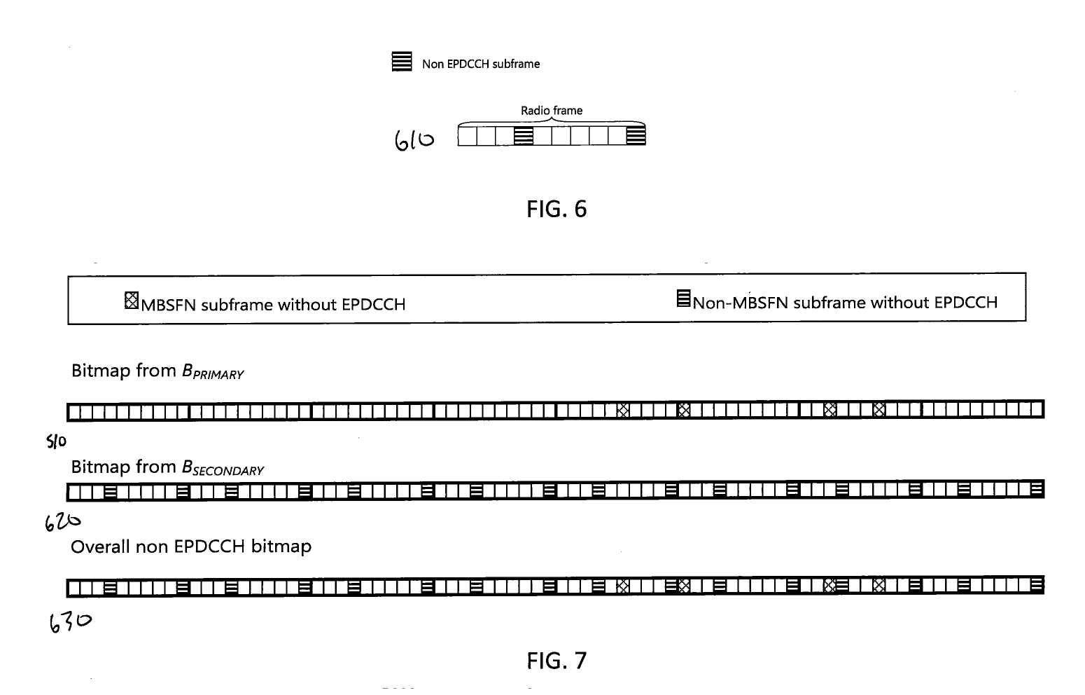

According to at least one example embodiment, in addition to B_{PRIMARY} 410, a secondary bitmap B_{SECONDARY} 610 may be used to indicate to a UE which subframes to monitor for the EPDCCH. FIG. 6 illustrates the secondary bitmap B_{SECONDARY} 610. In FIG. 6 entries in B_{SECONDARY} 610 corresponding to Non EPDCCH subframes are indicated by a pattern of horizontal lines. FIG. 7 illustrates a relationship between the first non-EPDCCH bitmap 510, a second non-EPDCCH bitmap 620 and a combined non-EPDCCH bitmap 630. In FIG. 7 entries in the first non-EPDCCH bitmap 510 and the combined non-EPDCCH bitmap 630 which correspond to MBSFN subframes that are non-EPDCCH subframes are indicated by a diamond pattern. Further, entries in the second non-EPDCCH bitmap 620 and the combined non-EPDCCH bitmap 630 which correspond to non-MBSFN subframes that are non-EPDCCH subframes are indicated by a pattern of horizontal lines. As is discussed above, B_{PRIMARY} 410 identifies non-EPDCCH subframes from among MBSFN subframes. According to at least one example embodiment, B_{SECONDARY} 610 may be used to identify non-EPDCCH subframes from among subframes that are not MBSFN subframes. According to at least one example embodiment, B_{SECONDARY} 610 may include a “1” for each sent subframe which does not include the EPDCCH intended for the UE receiving the subframe, and B_{SECONDARY} 610 may include a “0” for each sent subframe which does include the EPDCCH intended for the UE receiving the subframe. B_{SECONDARY} 610 may correspond to, for example a single radio frame from among the radio frames sent from an eNB to a UE. Further, B_{SECONDARY} 610 may represent each of the radio frames sent from the eNB to the UE. For example, in a case where B_{SECONDARY} 610 is sent from the eNB 120 to the UE 110, the UE 110 may interpret the single-frame representation of B_{SECONDARY} 610 as corresponding to a repeating pattern of non-EPDCCH subframes over plurality of radio frames. For example, the UE 110 may form the second non-EPDCCH bitmap 620 by repeating B_{SECONDARY} 610 a plurality of times. In the example illustrated in FIG. 7, B_{SECONDARY} 610 is repeated 8 times.

Accordingly, the number of bits required to send B_{SECONDARY} 610 from an eNB to a UE may remain relatively small. For example, B_{SECONDARY} 610 may be sent from an eNB to a UE using RRC signaling.

Once a UE has generated the first non-EPDCCH bitmap 510 and the second non-EPDCCH bitmap 620, the UE may generate the combined EPDCCH bitmap 630. As is illustrated in FIG. 7, the combined EPDCCH bitmap 630 may be generated by the UE for example, by performing an OR operation on the first non-EPDCCH bitmap 510 and the second non-EPDCCH bitmap 620.

Like the first non-EPDCCH bitmap 510, in a case where the UE 110 generates the combined non-EPDCCH bitmap 630 based on a plurality of subframes included in a plurality of radio frames sent to from the eNB 120 to the UE 110, the combined EPDCCH bitmap 630 is logically mapped to the sent subframes such that consecutive entries in the first combined non-EPDCCH bitmap 630 correspond, respectively, to consecutive subframes from among the sent subframes. Further, according to at least one example embodiment, the combined non-EPDCCH bitmap 630 may include a “1” for each sent subframe which does not include the EPDCCH, and combined non-EPDCCH bitmap 630 may include a “0” for each sent subframe which does include the EPDCCH. Consequently, according to at least one example embodiment, the UE 110 monitors for the EPDCCH during each subframe received from the eNB 120 which logically maps to a “0” in the combined non-EPDCCH bitmap 630, and the UE 110 does not monitor for the EPDCCH during each subframe received from the eNB 120 which logically maps to a “1” in the combined non-EPDCCH bitmap 630.

According to at least one example embodiment, in addition to B_{PRIMARY} 410, a secondary bitmap B_{I-SECONDARY} may be used to indicate to a UE which subframes to monitor for the EPDCCH. The bitmap B_{I-SECONDARY} may be used by an eNB and UE in the same manner as the bit map B_{SECONDARY} 610 discussed above with reference to FIGS. 6 and 7 with the exception that, instead of identifying subframes which should not be monitored by a UE, as does B_{SECONDARY} 610, B_{I-SECONDARY} identifies subframes that should be monitored by the UE. Accordingly, B_{I-SECONDARY} can be used to indicate a UE that a subframe should be monitored even if the subframe is identified as a non-EPDCCH subframe by another bit map, for example B_{PRIMARY} 410. For example, B_{I-SECONDARY} may include a “1” for each sent subframe which a UE should monitor for the EPDCCH, and B_{I-SECONDARY} may include a “0” for the remaining subframes. The UE may monitor subframes corresponding to the value “1” in B_{I-SECONDARY} for the EPDCCH regardless of whether or not those subframes are identified as non-EPDCCH subframes by B_{PRIMARY} 410. Further, the manner in which the UE use B_{PRIMARY} 410 to monitor subframes may not be altered for subframes corresponding to the value “0” in B_{I-SECONDARY}.

In accordance with the methods described above with reference to FIGS. 3-7, the bitmaps B_{PRIMARY} 410 and B_{SECONDARY} 610 may be smaller in size than a bitmap including entries for each of a plurality of subframes being sent from an eNB to a UE. Accordingly, an amount of signaling overhead produced for the wireless system 100 when an eNB, for example the eNB 120, sends information identifying subframes which are to be monitored for the EPDCCH to a UE, for example the UE 110, may be reduced.

Example embodiments being thus described, it will be obvious that embodiments may be varied in many ways. Such variations are not to be regarded as a departure from example embodiments, and all such modifications are intended to be included within the scope of example embodiments.

What is claimed:

1. A method of specifying, for a user equipment (UE), non-enhanced physical downlink control channel (EPDCCH) subframes from among a plurality of subframes, the method comprising:
sending one or more first bitmaps from a base station to the UE, each of the one or more first bitmaps being logically mapped to the plurality of subframes and identifying first subframes, the first subframes being subframes from among the plurality of subframes that belong to one of one or more first groups;
sending a second bitmap from the base station to the UE, the second bitmap being logically mapped to the first subframes and identifying the non-EPDCCH subframes from among the first subframes, the non-EPDCCH subframes being subframes that are not to be monitored by the UE for an EPDCCH; and
sending the plurality of subframes from a base station to the UE.

2. The method of claim 1, further comprising:
determining the non-EPDCCH subframes from among the plurality of subframes; and
generating the second bitmap at the base station based on the determined non-EPDCCH subframes.

3. The method of claim 1, wherein the one or more first bitmaps are multicast-broadcast single frequency network (MBSFN) bitmaps, and the one or more first groups are one or more groups of MBSFN subframes from among the plurality of subframes.

4. A method of determining, at a user equipment (UE), non-enhanced physical downlink control channel (non-EPDCCH) subframes from among a plurality of subframes, the method comprising:
receiving the plurality of subframes at the UE;
receiving one or more first bitmaps at the UE, each of the one or more first bitmaps being logically mapped to the plurality of subframes and identifying first subframes, the first subframes being subframes from among the plurality of subframes that belong to one of one or more first groups;
receiving a second bitmap at the UE, the second bitmap being logically mapped to the first subframes and identifying subframes from among the first subframes as non-EPDCCH subframes;
determining which of the plurality of subframes are EPDCCH-possible subframes based on the second bitmap, the EPDCCH-possible subframes being subframes having an EPDCCH intended for the UE; and
monitoring only the subframes determined to be EPDCCH-possible subframes for the EPDCCH.

5. The method of claim 4, wherein the one or more first bitmaps are multicast-broadcast single frequency network (MBSFN) bitmaps, and the one or more first groups are one or more groups of MBSFN subframes from among the plurality of subframes.

6. The method of claim 4, further comprising:
receiving a third bitmap at the UE, the plurality of subframes being divided into a plurality of frames, the third bitmap being logically mapped to a representative frame from among the plurality of frames, and identifying subframes from among the subframes in the representative frame as non-EPDCCH subframes; and
forming a fourth bitmap by repeating the third bitmap once for each frame in the plurality of frames,
wherein the determining includes determining, as the EPDCCH-possible subframes, subframes from among the plurality of subframes that are not identified as non-EPDCCH subframes by either the second bitmap or the fourth bitmap.

7. The method of 4, further comprising:
receiving a third bitmap at the UE, the plurality of subframes being divided into a plurality of frames, the third bitmap being logically mapped to a representative frame from among the plurality of frames, and identifying subframes from among the subframes in the representative frame as EPDCCH-including subframes; and
forming a fourth bitmap by repeating the third bitmap once for each frame in the plurality of frames,
wherein the determining includes determining, as the EPDCCH-possible subframes,
the EPDCCH-including subframes, and
subframes from among the plurality of subframes that are not identified as non-EPDCCH subframes by the second bitmap.

8. A network element comprising:
a processing unit configured to control operations for specifying, for a user equipment (UE), non-enhanced physical downlink control channel (EPDCCH) subframes from among a plurality of subframes, the operations including,
sending one or more first bitmaps from the network element to the UE, each of the one or more first bitmaps being logically mapped to the plurality of subframes and identifying first subframes, the first subframes being subframes from among the plurality of subframes that belong to one of one or more first groups;
sending a second bitmap from the network element to the UE, the second bitmap being logically mapped to the first subframes and identifying the non-EPDCCH subframes from among the first subframes, the non-EPDCCH subframes being subframes that are not to be monitored by the UE for an EPDCCH; and
sending the plurality of subframes from a base station to the UE.

9. The network element of claim 8, wherein the processor is further configured to control operations including,
determining the non-EPDCCH subframes from among the plurality of subframes; and
generating the second bitmap at the network element based on the determined non-EPDCCH subframes.

10. The network element of claim 8, wherein the one or more first bitmaps are multicast-broadcast single frequency network (MBSFN) bitmaps, and the one or more first groups are one or more groups of MBSFN subframes from among the plurality of subframes.

11. A mobile device comprising:
a processing unit configured to control operations for determining non-enhanced physical downlink control channel (non-EPDCCH) subframes from among a plurality of subframes, the operations including,
receiving the plurality of subframes at the mobile device;
receiving one or more first bitmaps at the mobile device, each of the one or more first bitmaps being logically mapped to the plurality of subframes and identifying first subframes, the first subframes being subframes from among the plurality of subframes that belong to one of one or more first groups;
receiving a second bitmap at the mobile device, the second bitmap being logically mapped to the first subframes and identifying subframes from among the first subframes as non-EPDCCH subframes;
determining which of the plurality of subframes are EPDCCH-possible subframes based on the second bitmap, the EPDCCH-possible subframes being subframes having an EPDCCH intended for the mobile device; and
monitoring only the subframes determined to be EPDCCH-possible subframes for the EPDCCH.

12. The mobile device of claim 11, wherein the one or more first bitmaps are multicast-broadcast single frequency network (MBSFN) bitmaps, and the one or more first groups are one or more groups of MBSFN subframes from among the plurality of subframes.

13. The mobile device of claim 11, wherein the processing unit is further configured to control operations including,
receiving a third bitmap at the mobile device, the plurality of subframes being divided into a plurality of frames, the third bitmap being logically mapped to a representative frame from among the plurality of frames, and identifying subframes from among the subframes in the representative frame as non-EPDCCH subframes; and
forming a fourth bitmap by repeating the third bitmap once for each frame in the plurality of frames,
wherein the determining includes determining, as the EPDCCH-possible subframes, subframes from among the plurality of subframes that are not identified as non-EPDCCH subframes by either the second bitmap or the fourth bitmap.

14. The method of 11, wherein the processing unit is further configured to control operations including,
receiving a third bitmap at the mobile device, the plurality of subframes being divided into a plurality of frames, the third bitmap being logically mapped to a representative frame from among the plurality of frames, and identifying subframes from among the subframes in the representative frame as EPDCCH-including subframes; and
forming a fourth bitmap by repeating the third bitmap once for each frame in the plurality of frames,
wherein the determining includes determining, as the EPDCCH-possible subframes,
the EPDCCH-including subframes, and
subframes from among the plurality of subframes that are not identified as non-EPDCCH subframes by the second bitmap.
